(19) United States
(12) Patent Application Publication
(10) Pub. No.: US 2021/0283988 A1
(43) Pub. Date: Sep. 16, 2021

(54) RADIANT PANEL FOR INSTALLATION INSIDE A VEHICLE PASSENGER COMPARTMENT

(71) Applicant: Valeo Systemes Thermiques, Le Mesnil-Saint-Denis (FR)

(72) Inventors: Georges De Pelsemaeker, Le Mesnil Saint-Denis (FR); Harry Tshilolo, Le Mesnil Saint Denis (FR); Franck Martin, Le Mesnil Saint Denis (FR); Vania-Daniela Hernandez-Bello, Le Mesnil Saint Denis (FR)

(73) Assignee: Valeo Systemes Thermiques, Le Mesnil-Saint-Denis (FR)

(21) Appl. No.: 17/255,723

(22) PCT Filed: Jun. 11, 2019
(86) PCT No.: PCT/FR2019/051404

§ 371 Date: Dec. 23, 2020

(30) Foreign Application Priority Data
Jun. 27, 2018 (FR) 1855744

(51) Int. Cl. B60H 1/22

(52) U.S. Cl. CPC B60H 1/2227; B60H 1/2225; B60H 2001/2287; B60H 1/2226; B60H 1/2218

(57) ABSTRACT

A radiant panel (3) intended to be installed inside a passenger compartment (1) of a vehicle (2), a motor vehicle for example, is disclosed. The radiant panel (3) includes a dissipative region (10) arranged to generate heat by Joule heating and at least one functional component (17) arranged to perform at least one function other than generating heat by Joule heating in the dissipative region (10).

The field of the present invention relates to the radiant panels arranged inside a passenger compartment of a vehicle, a motor vehicle for example. The invention more particularly relates to a radiant panel configured to heat and to perform a function other than producing heat. The invention also relates to the passenger compartment of a vehicle that is equipped with such a radiant panel.

At the present time, the management of passenger comfort and well-being in a vehicle is adapting to changes in mobility (eco-sharing, carpooling, electrification, connectivity, etc.). In the era of autonomous driving and new sharing practices, user expectations have changed. The passenger compartment is no longer seen as a waiting area but also as a space for relaxation and conviviality.

Much development work has been carried out to functionalize the passenger compartment of current-day vehicles, in order to meet the growing needs in terms of comfort and well-being. Passengers are able to interact with elements present on the surface of the passenger compartment, especially by virtue of connected, functional and decorative technologies. These smart surfaces offer passengers a poly-sensory experience. Systems for managing comfort in the passenger compartment that are integrated into such surfaces are for example:
adaptive lighting: variable brightness, mood generator according to needs (rest, awakening, work, leisure), etc.
odor diffusers: particular ambiance, scent to prevent motion sickness, etc.
acoustic management devices: attenuation of parasitic noises in the passenger compartment, playback of background music, etc.
thermal comfort devices: heated steering wheels and seats, radiant panels, etc.

In addition to the increasing functionalization of surfaces within the passenger compartment, there is a need to provide vehicles with the ability to adapt to the contexts of use, in order to better manage individual comfort. At the present time, comfort management relies, for example, on sensors (temperature sensors, sensory sensors, infrared cameras, etc.) and on actuators (radiant panels, etc.).

Radiant panels play an active role in the comfort of vehicle users in the passenger compartment into which they are integrated. The surface of the radiant panel heats the passengers with infrared radiation while heating the air located inside the passenger compartment by convection. They have shapes and dimensions adapted to their location within the vehicle. They may for example be integrated into a seat, a dashboard, a roof, a pillar, an armrest, etc. A radiant panel may therefore be considered an interface, the main function of which is to ensure thermal comfort within the passenger compartment of the vehicle.

It is known that in order to control the heating surface of a radiant panel (in particular to regulate the temperature level) integrated into the vehicle, passengers located near such a panel may use a human-machine interface (HMI). This interaction may in particular be performed via the central human-machine interface of the vehicle or else via the conventional human-machine interface of the air conditioning system.

The temperature of the heating surface of a radiant panel may be regulated automatically by virtue of a control device incorporating sensors on the surface of the radiant panel. This solution is presented in document DE202016008434. Sensors placed on the surface (for example pressure-sensitive sensors and/or capacitive sensors) are able to detect when an object (part of the body, etc.) comes into contact with the heating surface, and to activate a temperature control device accordingly. Alternatively, the temperature may also be controlled at the request of the user via direct activation of an actuator placed on the surface, such as a button or a touch screen.

The device presented in the aforementioned document merely addresses use of a temperature control interface of a radiant panel to ensure the thermal comfort of the user. In addition, since the device only activates when necessary (detection of an object in the perimeter of the heating surface), wasting energy is thus avoided.

Document KR201600898112 provides an interface that is more sophisticated than the aforementioned device, which interface also employs visual indicators (lamp off or on) and audible indicators (emission of an audible signal) to notify the user that the heating device has been turned on or off.

Therefore, none of these documents proposes to functionalize the surface of a radiant panel other than for the purpose of thermal comfort (regulation of the heating temperature of the surface of the radiant panel or indication of its operation).

In the general case, the conventional interfaces of the vehicle (management of thermal comfort, management of lighting, management of sound volume, etc.) are arranged at a distance from one another and are not interconnected. This arrangement does not facilitate the interaction of passengers with the functional elements of the vehicle. However, at the present time there is a need to optimize as much as possible the management of the interfaces integrated into the vehicle, and in particular to facilitate control of their various functionalities.

Therefore, the objective of the present invention is to assemble a plurality of functionalities in a single radiant panel. Such a radiant panel is therefore capable of offering users, in addition to heating means, a plurality of components intended, for example, for the comfort and well-being of the user, and with which it is easy to interact.

One subject of the invention is a radiant panel intended to be installed inside a passenger compartment of a vehicle, a motor vehicle for example, the radiant panel comprising:
a dissipative region arranged to generate heat by Joule heating,
at least one functional component arranged to perform at least one function other than generating heat by Joule heating in the dissipative region.

A multifunctional radiant panel such as described above meets the stated objectives, this radiant panel having both a thermal heating function and a function other than heating the users.

According to one or more features that may be implemented alone or in combination, it is possible to make provision for:
The functional component to be placed at least partially in the dissipative region.
The functional component to be placed entirely in the dissipative region.
The functional component to be placed entirely outside the dissipative region.
The radiant panel to further comprise a first electrode and a second electrode that are arranged to at least produce an electric current in the dissipative region so as to generate heat.
At least one of the electrodes to comprise at least one dissipating branch and in particular a plurality of dissipating branches arranged to produce electric current that flows through the dissipative region between this branch and the other electrode so as to generate heat. The at least one of the electrodes that comprises at least one dissipating branch may irrespectively be the first electrode or the second electrode.
Each electrode to have a plurality of dissipating branches, arranged to produce electric current that flows through the dissipative region. In other words, the dissipating branches form a network that lies in the dissipative region, which is arranged to produce heat by Joule heating.
At least one of the dissipating branches of the first electrode to be arranged between two neighboring dissipating branches of the second electrode, so that the electric current may be set up between the dissipating branch of the first electrode and the two neighboring dissipating branches of the second electrode. The term “neighboring” is understood to mean that one at least of the dissipating branches of the first electrode is located at a sufficiently small distance from the two dissipating branches of the second electrode that the electric current is able to flow.
The plurality of dissipating branches of one of the electrodes to be electrically connected to a distributing branch of this electrode. The distributing branch is therefore a portion of the electrode in question (irrespectively a first or second electrode such as defined above). Each distributing branch partly plays the role of a supply line, feeding electric current to each of the electrodes to which it is assigned.
At least one of the distributing branches to be arranged outside the dissipative region.
The distributing branches to at least locally encircle the dissipative region.
At least one of the distributing branches to be arranged at least locally in the dissipative region.
At least one of the dissipating branches to comprise offshoots at one of its ends, in particular Y-shaped offshoots.
The dissipating branches to be parallel to one another.
The dissipating branches to have a free end.
At least one of the electrodes to comprise at least one additional branch arranged to act as an electrode for the at least one functional component.
The additional branch to be arranged outside the dissipative region.
The additional branch to be connected to the distributing branch.
The two electrodes to each comprise an additional branch, these two additional branches serving as an electrode for the at least one functional component.
At least one of the additional branches to comprise offshoots at one of its ends, in particular Y-shaped offshoots.
The additional branches to be parallel to one another.
The additional branches to have a free end.
The additional branches to be arranged outside the dissipative region.
The dissipative region to have a shape chosen from any one of the following shapes: polygonal, rectangular, square, oval, circular, trapezoidal.
The dissipative region to consist of a layer referred to as the layer for generating warmth.
The layer for generating warmth to comprise a plurality of layers.
The layer for generating warmth to comprise at least one heating element, in particular a plurality of heating elements, and at least two electrodes, the at least two electrodes being configured to electrically power the heating element. Thus under the effect of the electrical power supplied by the electrodes, the heating element emits heat via Joule heating.
The heating element to be arranged in a thin layer.
Advantageously, the thin layer to have a thickness smaller than 250 microns.
The heating element to further comprise a coat of acrylic paint containing carbon (for example graphene or graphite) particles and/or metal particles.
Each heating element to be placed between two electrodes.
The two electrodes configured to electrically power the heating element to be elongate and arranged parallel to each other.
The dissipative region to further comprise a protective layer for protecting, electrically for example, the layer for generating warmth.
The layer for generating warmth and the protective layer to be securely fastened to each other.
The layer for generating warmth and the protective layer to at least partly make contact with each other.
The protective layer to consist of a material chosen from: a paint, a varnish or a film.
The protective layer to be covered with a sheet having a trim function.
The sheet to be made of a material chosen from: a fabric, a leather, a wood, a paint or any other material able to give the radiant panel an aesthetic appearance.
The functional component may be chosen from:
   a light source,
   a scent diffuser,
   a control and/or information screen, or a touch control box,
   a sound transmitter,
   a sound receiver,
   a biosensor,
   an actuator such as a button or a potentiometer,
   a radar transceiver or a radio transceiver,
   an ambiance sensor,
   a haptic controller or device,
   or any other device dedicated to the well-being and/or comfort of said one or more passengers of the vehicle.
The light source may be chosen from: a diode, an optical conductor, a light emitter such as a lamp, a light diffuser, a network of optical fibers.
The odor diffuser may be chosen from: a perfume diffuser, a fragrance diffuser, an essential-oil diffuser.
The sound emitter may be chosen from: a loudspeaker, a sound system (in particular equipped with a Bluetooth function), a radio, a vibrating surface.
The sound receiver may be chosen from: a microphone, a sensitive surface.
The biosensor to be chosen to measure at least one datum representative of the physiological state of the one or more passengers of the vehicle.
The biosensor may operate with and/or without touch contact.
The ambiance sensor may be chosen from: a temperature sensor, a pressure sensor, a humidity sensor, or any other sensor allowing the state of comfort and/or well-being of said one or more passengers of said vehicle to be measured.
The radiant panel to be configured so that the dissipative region and the at least one functional component are located on the same side of the radiant panel or located on two opposite sides of the radiant panel.
The radiant panel to be configured so that at least one functional component is implanted between at least two constituent layers of the layer for generating warmth.
The function other than generating or controlling the generation of heat by Joule heating in the dissipative region to allow feedback to be provided on user experience and/or the radiant panel to be controlled.
The feedback on user experience to depend on at least one characteristic linked to the user's profile.
The characteristic linked to the profile of said user to be chosen from:
   a physiological characteristic,
   a state of health,
   a level of well-being,
   a level of vigilance,
   an item of lifestyle information.
The physiological characteristic of said user to be chosen from: metabolic activity, age, sex, weight, sensitivity of a part of the body to heat and/or cold.
An electronic control unit to control operation of at least one of the functional components.
The radiant panel may further comprise additional functional components arranged to perform at least one function other than generating heat by Joule heating in the dissipative region, these functional components not being electrically connected to the network of electrodes of the radiant panel. By way of illustrative but non-limiting examples, these additional functional components may be chosen from: wireless sensors that get their energy from an external source (for example, solar energy) or from an independent battery (the external source of energy is then a source of chemical energy), and active or passive sensors exploiting surface acoustic waves (SAW) of radio-frequency identification (RFID) technologies. The signals associated with at least one of the aforementioned technologies are radio frequency signals or acoustic waves.
The electrical power supplied to the radiant panel to be generated from a DC signal or from a pulse-width-modulated (PWM) signal so as to provide an average power to the dissipative region.
In order to achieve the transmission of information between the functional components integrated into the radiant panel and the exterior of the radiant panel (in particular the central processing unit) it may be envisioned for the signals to be integrated into the device which supplies the electric power to the radiant panel. These signals may be modulated or demodulated by each function associated with a particular functional component. The modulation may be performed at low frequency or at high frequency.
According to an exemplary embodiment of the invention, the functional component is powered electrically via conductive tracks that are separate from the dissipating branches and the additional branches. This or these conductive tracks are arranged outside the layer of the panel that accommodates the dissipating branches and the additional branches. This or these conductive tracks may be embedded in a layer of the panel or be on the surface thereof.
As a variant, the functional component is electrically powered using at least one of the dissipating and/or additional branches.

Another subject of the invention is a motor-vehicle passenger compartment comprising at least one bodywork element and/or at least one passenger-compartment element, the bodywork element and/or the passenger-compartment element comprising at least one radiant panel such as defined above. The bodywork element on which the radiant panel is placed may comprise at least one slab facing the outside of the passenger compartment and a thermally insulating element interposed between the slab and the radiant panel. The thermally insulating element is an air gap or a felt panel.

The bodywork element is chosen from a door or a roof and the passenger-compartment element is chosen from a seat, a seat element, a dashboard, a footwell and/or an armrest.

Further features, details and advantages of the invention will emerge upon reading the description given below by way of indication with reference to the drawings, in which:

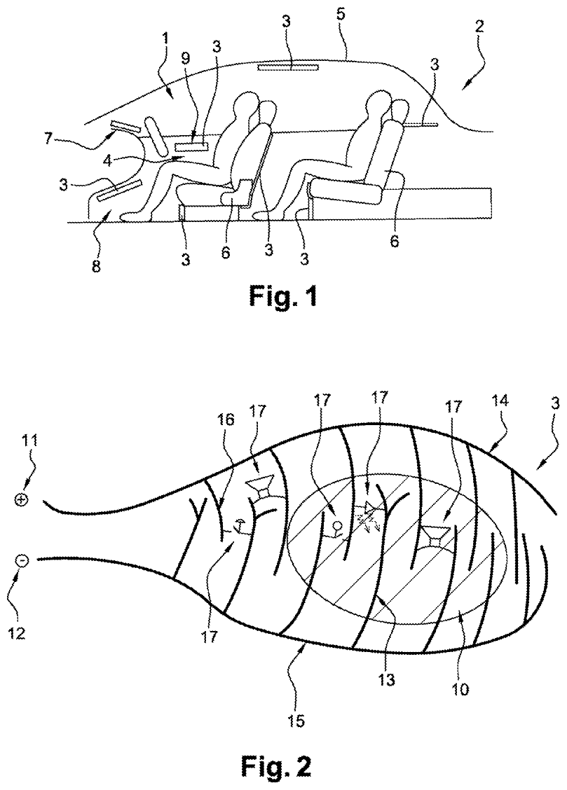

FIG. 1 is a schematic view of a vehicle passenger compartment in which are positioned one or more radiant panels according to the invention,

FIG. 2 is a schematic face-on view of a radiant panel according to the invention,

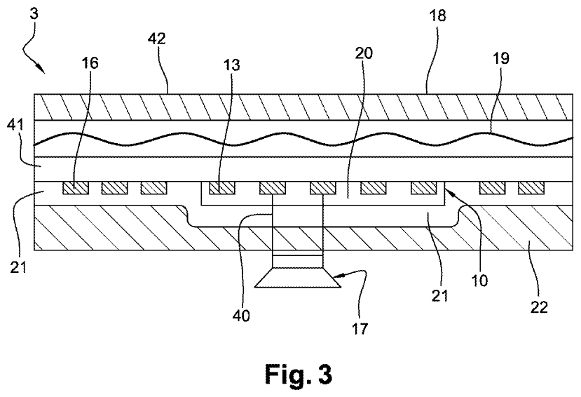

FIG. 3 is a schematic cross-sectional view of a radiant panel according to the invention.

The features, variants and various embodiments of the invention may be associated with one another, in various combinations, provided that they are not mutually incompatible or exclusive. It is possible, in particular, to imagine variants of the invention comprising only a selection of the features described below, in isolation from the other described features, if this selection of features is sufficient to confer a technical advantage or to distinguish the invention from the state of the art.

In particular, all of the variants and all of the embodiments described may be combined with each other if there is no technical reason preventing this combination.

It should be noted that the figures illustrate the invention in detail with a view to the implementation of the invention. Said figures may of course serve to better define the invention, where appropriate.

In the figures, elements common to a number of figures keep the same reference.

In the present invention, certain elements may be indexed (such as for example first element or second element, etc.). Unless stated otherwise, it is a question of simple indexing, to differentiate between and name elements that are similar but not identical. This indexing does not imply priority of one element with respect to another and such denominations may easily be interchanged without departing from the scope of the present description.

FIG. 1 illustrates a passenger compartment 1 of a motor vehicle 2 equipped with at least one radiant panel 3 according to the invention. Radiant panels 3 according to the invention are distributed within the passenger compartment 1 to locally generate heat in the direction of the regions intended to be occupied by one or more users of the motor vehicle 2. According to the example illustrated in FIG. 1, the radiant panels 3 according to the invention are arranged on various interior surfaces of the passenger compartment 1, such as for example a door 4, a roof 5, a seat 6, an element of a seat 6 (headrest, backrest, seat base, etc.), a dashboard 7, a lower part of the dashboard such as a footwell 8 and/or an armrest 9. Obviously, other interior surfaces could be equipped with radiant panels 3 according to the invention depending on the needs of each user and/or depending on the configuration of the passenger compartment 1. By interior surface what is meant is any surface facing the regions of the passenger compartment 1 that are occupied by the passengers of the motor vehicle 2.

FIG. 2 shows a radiant panel 3 according to the invention comprising a dissipative region 10 arranged to generate heat by Joule heating. Advantageously, the dissipative region 10 has an oval shape. Obviously, depending on the arrangement of the radiant panel 3 within the passenger compartment 1, the dissipative region may be another shape, such as a rectangle, a square, a circle, or a trapezoidal shape. These shapes are given by way of illustrative and non-limiting examples of the present invention. The radiant panel 3 further comprises a first electrode 11 and a second electrode 12 that are arranged to produce an electric current in the dissipative region 10 so as to generate heat by Joule heating.

The first electrode 11 and the second electrode 12 are organized within the radiant panel 3 as follows: each of the electrodes comprises a plurality of dissipating branches 13. These dissipating branches 13 are arranged to produce electric current in the dissipative region 10, this electric current flowing through the dissipative region 10 between one of the dissipating branches 13 belonging to the first electrode 11 and one of the dissipating branches 13 belonging to the second electrode 12. In the example shown in FIG. 2, the dissipating branches 13 are arranged substantially in alternation with one another (so-called “comb” arrangement). Thus, at least one of the dissipating branches 13 of the first electrode 11 is arranged between two neighboring dissipating branches 13 of the second electrode 12, so that the electric current may be set up between the dissipating branch of the first electrode 11 and the two neighboring dissipating branches of the second electrode 12.

The term “neighboring” is understood to mean that at least one of the dissipating branches of the first electrode is located at a sufficiently small distance from the two dissipating branches of the second electrode that the electric current is able to flow through the dissipative region 10.

The plurality of dissipating branches 13 of the first electrode 11 is electrically connected to a distributing branch 14 of the first electrode 11. Reciprocally, the plurality of dissipating branches 13 of the second electrode 12 is electrically connected to a distributing branch 15 of the second electrode 12. By distributing branch what is meant is the portion of the electrode (first electrode 11 or second electrode 12) that is connected to an electrical power source.

In the exemplary embodiment shown in FIG. 2, the distributing branches 14 and 15 are arranged such that they encircle the dissipative region 10 at least locally. Of course, the invention is not limited to this exemplary embodiment, and it is possible to design a radiant panel in which the distributing branches are both arranged outside the dissipative region 10, or in contrast both arranged in the dissipative region 10 at least locally. In another exemplary embodiment, it is possible to imagine a radiant panel in which one of the distributing branches is arranged outside the dissipative region 10 and in which the other distributing branch is arranged at least locally in the dissipative region 10.

Thus, the distributing branches 14 and 15 are electrically connected to an electrical power source able to deliver an electric current of a magnitude I. This current flows through the distributing branches 14 and 15. The electric power source is also able to deliver a voltage U applied across the distributing branch 14 and the distributing branch 15.

FIG. 2 shows that certain of the dissipating branches 13 comprise offshoots at one of their ends, certain offshoots being Y-shaped, whereas other dissipating branches 13 have a free end.

In the electrical portion of the radiant panel 3 located outside the dissipative region 10, each of the electrodes 11 or 12 comprises at least one additional branch 16 arranged to serve as an electrode for at least one functional component 17. The additional branches 16 are arranged outside the dissipative region 10 and each of them is connected to one of the distributing branches. Certain of these additional branches 16 comprise offshoots (which are Y-shaped for example) at one of their ends, whereas others have a free end.

According to this exemplary embodiment, the dissipating branches 13 and the additional branches 16 are arranged substantially perpendicular to the distributing branches 14 and 15. Furthermore, the dissipating branches 13 and the additional branches 16 are arranged substantially parallel to one another. They also have a substantially equal length. However, depending on the shape given to the radiant panel 3 and depending on its location within the passenger compartment 1, the length of each of the dissipating branches 13 and additional branches 16 may vary to match the variation in the dimensions of the radiant panel 3.

According to the embodiment illustrated in FIG. 2, certain functional components 17, the function of which is not to generate warmth by Joule heating, are located within the dissipative region 10, whereas others are arranged outside said dissipative region 10. It is possible to imagine a radiant panel 3 according to the invention in which all the functional components 17 are arranged outside the dissipative region 10. A functional component 17 is only electrically active if one of its electrical connections is assigned to one of the distributing branches (for example the distributing branch 14) and the other of its electrical connections is assigned to the other distributing branch (the distributing branch 15 in this example). In the example of the arrangement of the functional components 17 shown in FIG. 2, the functional components 17 located in the dissipative region 10 are electrically connected to dissipating branches 13, whereas functional components 17 located outside of the dissipative region 10 are electrically connected to additional branches.

The functional components 17 in the example illustrated in FIG. 2 are five in number. However, it should be noted that the number of functional components 17 within the electrode network is a non-limiting parameter of the present invention, the invention not being limited by the number of functional components. The size of the radiant panel may be a parameter limiting the number of functional components integrated into the network of electrodes. RFID components, or energetically stand-alone components, although not shown in FIG. 2, may also be implemented in the radiant panel.

In the example illustrated in FIG. 2, the functional components 17 are chosen from: a diode, a loudspeaker, and an actuator such as a button. Of course, the invention is not limited to this type of functional component and depending on user needs and the location of the radiant panel 3 within the passenger compartment 1, other functional components 17 may be envisioned. Thus, the functional component 17 may be chosen from:
a light source,
a scent diffuser,
a control and/or information screen, or a touch control box,
a sound transmitter,
a sound receiver,
a biosensor,
an actuator such as a button or a potentiometer,
a radar transceiver or a radio transceiver,
an ambiance sensor,
a haptic controller or device,
or any other device dedicated to the well-being and/or comfort of said one or more passengers of the vehicle.

The electrodes 11 and 12 may for example be obtained by screen-printing.

The electrical power supplied to the radiant panel 3 may be generated from a DC signal or from a pulse-width-modulated (PWM) signal so as to provide an average power to the dissipative region 10.

FIG. 3 shows a cross section of a radiant panel 3 according to the invention. The radiant panel 3 is arranged on a bodywork element 18 of the passenger compartment 1 of the motor vehicle 2. This bodywork element 18 comprises at least one slab 42 facing the outside of the passenger compartment 1. Advantageously, the bodywork element 18 comprises at least one thermally insulating element 19. The thermally insulating element 19 may be a layer of material having thermally insulating properties (sheet of felt made of natural or synthetic fibers for example). The slab 42 allows the radiant panel 3 to be held against the bodywork element 18 of the motor vehicle 2. The thermally insulating element 19 makes it possible to prevent the dissipation of heat to regions that do not allow the passenger compartment 1 to be heated.

Such as shown in FIG. 3, the radiant panel 3 advantageously comprises a binding sub-layer 41 that is arranged between the thermally insulating element 19 and the layer 20 for generating warmth by Joule heating. As shown in FIG. 3, at least one portion of the binding sub-layer 41 makes contact with a protective layer 21. The binding sub-layer 41 comprises a material having electrical properties, a high adhesion and/or a low roughness. Such a material may be chosen from polyimides such as Kapton, or polyethylene terephthalates such as Mylar.

In this particular embodiment, the dissipative region 10 of the radiant panel 3 consists of a layer 20 for generating warmth by Joule heating. The layer 20 for generating warmth comprises at least one heating element, and in particular a plurality of heating elements, and at least two electrodes.

In the variant embodiment shown in FIG. 3, the dissipative region 10 comprises five dissipating branches 13 arranged parallel to one another. Certain dissipating branches belong to the first electrode and other branches belong to the second electrode of the network (this cannot be seen in FIG. 3 as it is a cross-sectional view of a radiant panel). These electrodes are configured to electrically power the heating element, which may then emit heat via Joule heating. The heating element may be arranged in a thin layer, i.e. in a layer having a thickness smaller than 250 microns. The heating element may further comprise a coat of acrylic paint constituted from carbon particles and/or metal particles. Each heating element is placed between two electrodes and at least two heating elements are arranged adjacently to each other. As shown in cross section in FIG. 3, the electrodes configured to electrically power the heating element are arranged parallel to each other.

In FIG. 3, the dissipative region 10 advantageously comprises a protective layer 21 for protecting the layer for generating warmth. The layer 20 for generating warmth and the protective layer 21 are securely fastened to each other and at least partly make contact with each other. The protective layer 21 may be made of a material chosen from: a paint, a varnish. The protective layer 21 is advantageously covered with a sheet 22, which serves as a trim therefor. The sheet 22 may be made of a material chosen from: a fabric, a leather, a wood, a paint or any other material able to give the radiant panel an aesthetic appearance.

In FIG. 3, a single functional component 17, in the present case a loudspeaker, has been shown in the dissipative region 10.

Of course, the functional components 17 are arranged such that electric current is able to flow through each of them. Thus, the component 17 is placed against the sheet 22 and comprises electrical connection tabs 40 that pass through the protective layer 21 and through the sheet 22, with a view to being electrically connected to the dissipating branches 13.

Obviously, the present invention is not limited to the integration of functional components 17 into the dissipative region 10. Thus, it is possible to arrange functional components 17 (not shown in FIG. 3) outside the dissipative region 10, these components being arranged against the sheet 22 and comprising electrical connection tabs 40 that pass through the protective layer 21 and through the sheet 22 with a view to being electrically connected to the additional branches 16.

To conclude, the above description shows how the invention makes it possible to meet the set objectives: to provide a radiant panel capable both of heating the passenger compartment within a vehicle, a motor vehicle for example, and of offering several functional components to users. These functional components are intended for the comfort and well-being of users and it is easy to interact with them, in particular because they are integrated into one and the same interface.

1. A radiant panel configured to be installed inside a passenger compartment of a motor vehicle, the radiant panel comprising:
a dissipative region arranged to generate heat by Joule heating; and
at least one functional component arranged to perform at least one function other than generating heat by Joule heating in the dissipative region.

2. The radiant panel as claimed in claim 1, said radiant panel further comprising a first electrode and a second electrode that are arranged to at least produce an electric current in the dissipative region so as to generate heat.

3. The radiant panel as claimed in claim 2, one of the electrodes comprising at least one dissipating branch and a plurality of dissipating branches arranged to produce electric current that flows through the dissipative region between this branch and the other electrode so as to generate heat.

4. The radiant panel as claimed in claim 2, each electrode comprising a plurality of dissipating branches.

5. The radiant panel as claimed in 4, at least one of the dissipating branches of the first electrode being arranged between two neighboring dissipating branches of the second electrode, so that the electric current may be set up between the dissipating branch of the first electrode and the two neighboring dissipating branches of the second electrode.

6. The radiant panel as claimed in claim 4, the plurality of dissipating branches of one of the electrodes being electrically connected to a distributing branch of the one electrode.

7. The radiant panel as claimed in claim 3, at least one of the dissipating branches comprising offshoots at one of its ends, in particular Y-shaped offshoots.

8. The radiant panel as claimed in claim 2, the two electrodes each comprising an additional branch, the two additional branches serving as an electrode for the at least one functional component.

9. The radiant panel as claimed in claim 8, the additional branch connecting to the distributing branch.

10. The radiant panel as claimed in claim 1, the dissipative region consisting of a layer for generating warmth.

11. The radiant panel as claimed in claim 1, the at least one functional component being chosen from:
a light source, an odor diffuser, a control and/or information screen, or a touch control box, a sound transmitter, a sound receiver, a biosensor, an actuator such as a button or a potentiometer, a radar transceiver, a radio transceiver, a receiving and/or transmitting antenna, an ambiance sensor, and a haptic controller or device.

12. The radiant panel as claimed in claim 1, the functional component being powered electrically via conductive tracks that are separate from the dissipating branches and the additional branches.

13. The radiant panel as claimed in claim 1, the electrical power delivered to the radiant panel being generated from a DC signal or from a pulse-width-modulated (PWM) signal so as to provide an average power to the dissipative region.

14. A passenger compartment of a motor vehicle, said passenger compartment comprising:
at least one bodywork element and/or at least one passenger-compartment element, the bodywork element and/or the passenger-compartment element comprising at least one radiant panel comprising:
a dissipative region arranged to generate heat by Joule heating, and
at least one functional component arranged to perform at least one function other than generating heat by Joule heating in the dissipative region.
